(19) United States
(12) Patent Application Publication
(10) Pub. No.: US 2010/0029397 A1
(43) Pub. Date: Feb. 4, 2010

(54) SLIP JOINT FOR USE IN A DRIVE TRAIN SYSTEM

(76) Inventors: Paul E. Schneider, Findlay, OH (US); Richard D. Taylor, Findlay, OH (US)

Correspondence Address: MARSHALL & MELHORN, LLC, FOUR SEAGATE, 8TH FLOOR, TOLEDO, OH, 43804, US

(21) Appl. No.: 12/181,730

(22) Filed: Jul. 29, 2008

(51) Int. Cl. F16D 3/06

(52) U.S. Cl. 464/162

(57) ABSTRACT

A sliding spline type of slip joint includes male and female splined members having portions that cooperate for concurrent rotational movement and for relative axial movement. A coating of a material is provided on the portion of the male splined member, and a plurality of ribs is provided on the coating of the material that cooperates with the portion of the female member. The ribs are separated by lands that do not cooperate with the portion of the female member. The pluralities of ribs may be circumferentially aligned with one another.

### BACKGROUND OF THE INVENTION

This invention relates in general to a slip joint including male and female members that cooperate for concurrent rotational movement and for relative axial movement. In particular, this invention relates to an improved structure for such a slip joint that is capable of minimizing both the amount of looseness between the male and female members thereof and the amount of force needed to effect relative axial movement thereof.

Drive train systems are widely used for generating power from a source and for transferring such power from the source to a driven mechanism. Frequently, the source generates rotational power, and such rotational power is transferred from the source to a rotatably driven mechanism. For example, in most land vehicles in use today, an engine/transmission assembly generates rotational power, and such rotational power is transferred from an output shaft of the engine/transmission assembly through a driveshaft assembly to an input shaft of an axle assembly so as to rotatably drive the wheels of the vehicle. To accomplish this, a typical driveshaft assembly includes a hollow cylindrical driveshaft tube having a pair of end fittings, such as a pair of tube yokes, secured to the front and rear ends thereof. The front end fitting forms a portion of a front universal joint that connects the output shaft of the engine/transmission assembly to the front end of the driveshaft tube. Similarly, the rear end fitting forms a portion of a rear universal joint that connects the rear end of the driveshaft tube to the input shaft of the axle assembly. The front and rear universal joints provide a rotational driving connection from the output shaft of the engine/transmission assembly through the driveshaft tube to the input shaft of the axle assembly, while accommodating a limited amount of angular misalignment between the rotational axes of these three shafts.

Not only must a typical drive train system accommodate a limited amount of angular misalignment between the source of rotational power and the rotatably driven device, but it must also typically accommodate a limited amount of relative axial movement therebetween. For example, in most vehicles, a small amount of relative axial movement frequently occurs between the engine/transmission assembly and the axle assembly when the vehicle is operated. To address this, it is known to provide a slip joint in the driveshaft assembly or elsewhere in the drive train system. A typical slip joint includes first and second members that have respective structures provided thereon that cooperate with one another for concurrent rotational movement, while permitting a limited amount of axial movement to occur therebetween. In a sliding spline type of slip joint, male and female members have respective pluralities of splines or similar structures provided thereon. A typical male splined member is generally cylindrical in shape and has a plurality of radially outwardly extending splines provided on the outer surface thereof. A typical female splined member, on the other hand, is generally hollow and cylindrical in shape and has a plurality of radially inwardly extending splines provided on the inner surface thereof. To assemble the slip joint, the male member is inserted within the female member such that the radially outwardly extending splines or other structures provided thereon cooperate with the radially inwardly extending splines or other structures provided on the female member. As a result, the male and female members are connected together for concurrent rotational movement. However, at the same time, the male member can move axially relative to the female member to accommodate a limited amount of relative axial movement between the engine/transmission assembly and the axle assembly of the drive train system during operation.

In order to facilitate relative axial movement between the male and female members of a slip joint, a certain amount of clearance is usually provided therebetween. However, a relatively large amount of clearance between the mating male and female members can result in an undesirable amount of looseness therebetween, which can cause adverse consequences. To minimize the adverse effects of such looseness, it is desirable that the amount of clearance provided between the mating male and female members be minimized. Unfortunately, when the amount of this clearance is relatively small, the magnitude of the force that is required to effect relative axial movement of the male and female members can become relatively large, which can cause other adverse consequences. Thus, it would thus be desirable to provide an improved structure for a slip joint that is capable of minimizing both the amount of looseness between the male and female members thereof and the amount of force needed to effect relative axial movement thereof.

### SUMMARY OF THE INVENTION

This invention relates to an improved structure for a slip joint that is capable of minimizing both the amount of looseness between the male and female members thereof and the amount of force needed to effect relative axial movement thereof.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a side elevational view of a vehicle drive train system including a first embodiment of a slip joint in accordance with this invention.

FIG. 2 is an enlarged side elevational view, partly in cross-section, of the first embodiment of the slip joint illustrated in FIG. 1.

FIG. 3 is a further enlarged sectional elevational view of a portion of the first embodiment of the slip joint illustrated in FIGS. 1 and 2.

FIG. 4 is a still further enlarged sectional elevational view of a spline of the first embodiment of the slip joint illustrated in FIGS. 1, 2, and 3.

FIG. 5 is a sectional elevational view similar to FIG. 4 illustrating a first alternative embodiment of the spline.

FIG. 6 is a sectional elevational view similar to FIG. 4 illustrating a second alternative embodiment of the spline.

FIG. 7 is a sectional elevational view similar to FIG. 3 of a second embodiment of the slip joint illustrated in FIGS. 1 and 2.

### DETAILED DESCRIPTION OF THE PREFERRED EMBODIMENTS

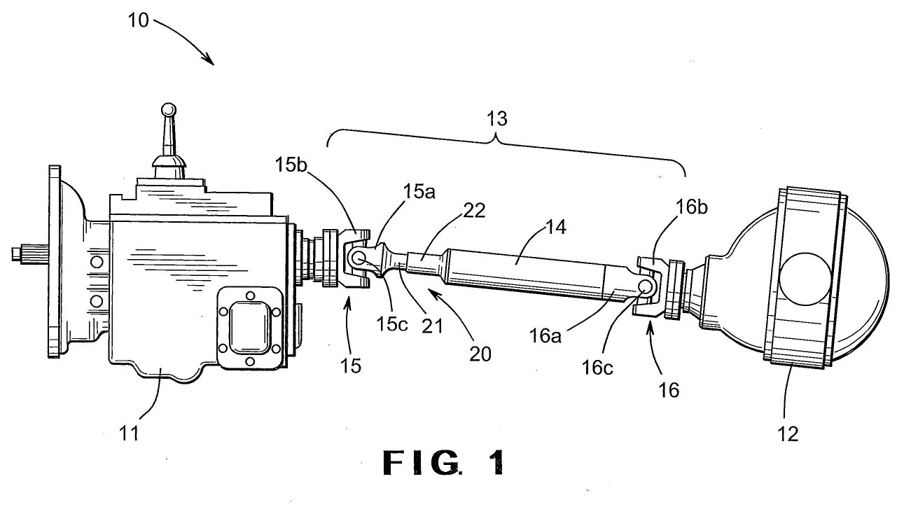

Referring now to the drawings, there is illustrated in FIG. 1 a drive train system, indicated generally at 10, in accordance with this invention. The illustrated drive train system 10 is, in large measure, conventional in the art and is intended merely to illustrate one environment in which this invention may be used. Thus, the scope of this invention is not intended to be limited for use with the specific structure for the drive train system 10 illustrated in FIG. 1 or with drive train systems in general. On the contrary, as will become apparent below, this invention may be used in any desired environment for the purposes described below.

The illustrated drive train system 10 is a vehicular drive train system that includes a transmission 11 having an output shaft (not shown) that is connected to an input shaft (not shown) of an axle assembly 12 through an axially adjustable driveshaft assembly 13. The axially adjustable driveshaft assembly 13 may be embodied as any two (or more) components that are connected together for concurrent rotational movement and for relative axial movement. In the illustrated embodiment, the axially adjustable driveshaft assembly 13 includes a driveshaft tube 14 and a slip joint, indicated generally at 20. The structure and operation of the slip joint 20 will be described in detail below.

The output shaft of the transmission 11 and the input shaft of the axle assembly 12 are typically not co-axially aligned. To accommodate this, the drive train system 10 further includes first and second universal joints, indicated respectively at 15 and 16. The universal joints 15 and 16 are conventional in the art and may each be embodied as any desired structure or structures that provide a rotational driving connection between input and output members, while accommodating a limited amount of angular misalignment between the rotational axes thereof. The first universal joint 15 is provided to connect the output shaft of the transmission 11 to the forward end of the driveshaft tube 14. In the illustrated embodiment, the first universal joint 15 includes a first end fitting 15a that is connected through the slip joint 20 to the forward end of the driveshaft tube 14, a second end fitting 15b that is connected to the output shaft of the transmission 11, and a cross assembly 15c that is connected to both the first end fitting 15a and the second end fitting 15b. Similarly, the second universal joint 16 is provided to connect the rearward end of the driveshaft tube 14 to the input shaft of the axle assembly 12. In the illustrated embodiment, the second universal joint 16 includes a first end fitting 16a that is connected to the rearward end of the driveshaft tube 14, a second end fitting 16b that is connected to the input shaft of the axle assembly 12, and a cross assembly 16c that is connected to both the first end fitting 16a and the second end fitting 16b. The universal joints 15 and 16 function in a manner that is well known in the art.

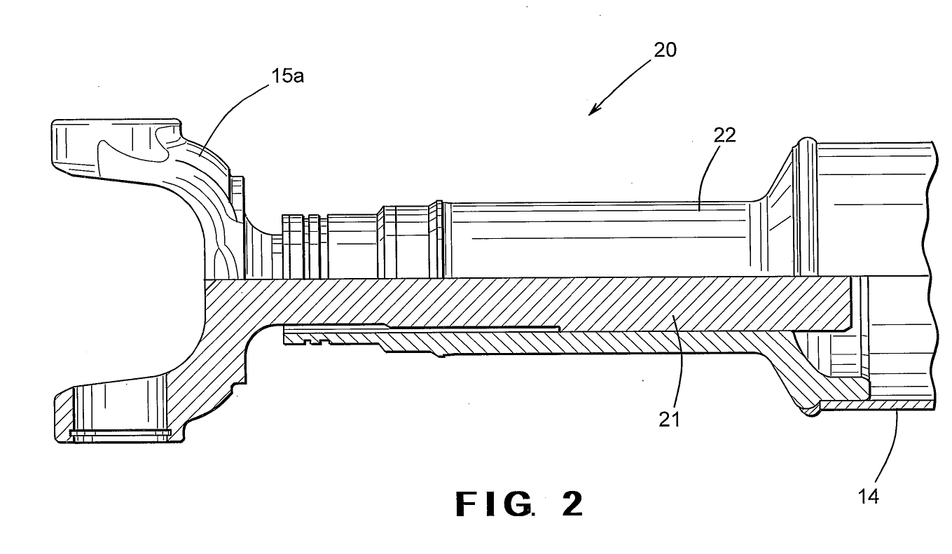

FIG. 2 illustrates in greater detail the structure of the slip joint 20 that connects the first end fitting 15a of the first universal joint 15 to the forward end of the driveshaft tube 14. As shown therein, the slip joint 20 includes a male member 21 that is secured to the first end fitting 15a of the first universal joint 15 and a female member 22 that is secured to the forward end of the driveshaft tube 14. In the illustrated embodiment, the male member 21 is formed integrally with the first end fitting 15a of the first universal joint 15, although such is not required. Also, in the illustrated embodiment, the female member 22 is secured to the forward end of the driveshaft tube by welding, although again such is not required. In a manner that will be explained in greater detail below, the male member 21 is inserted within the female member 22 such that the male and female members 21 and 22 cooperate with one another for concurrent rotational movement and for relative axial movement. Thus, the slip joint 20 allows a limited amount of relative axial movement to occur between the transmission 11 and the axle assembly 12 of the drive train system 10 during operation.

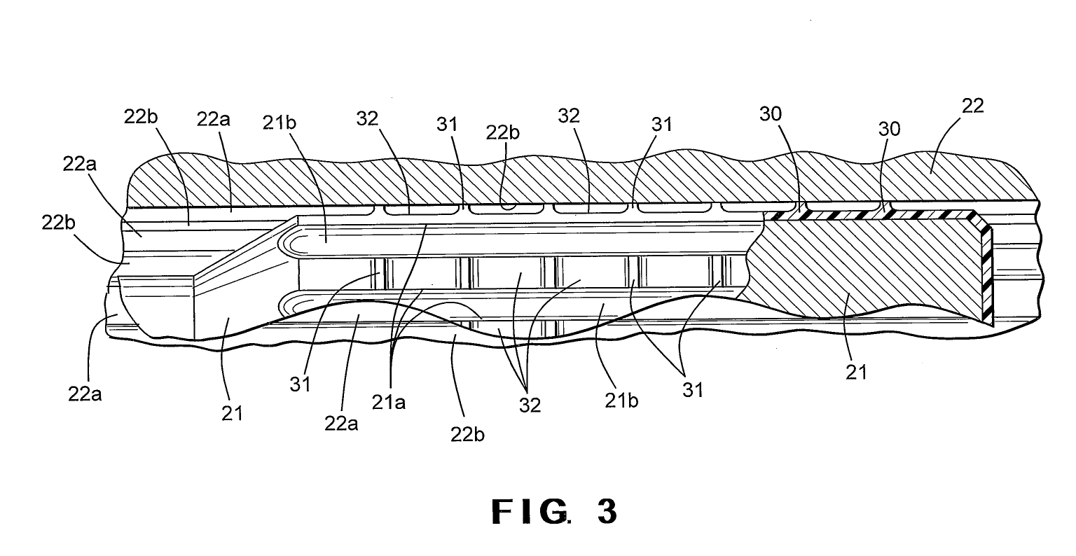

FIG. 3 is an enlarged sectional elevational view of a first embodiment of the slip joint 20 illustrated in FIG. 2. As shown therein, the male member 21 is an externally splined member that includes a plurality of axially extending splines 21 a that are separated from one another by axially extending recessed areas 21b. The illustrated splines 21a circumferentially spaced about the exterior of the male member 21 and extend radially outwardly toward the female member 22. Similarly, the female member 22 is a hollow, internally splined member that includes a plurality of axially extending splines 22a that are separated from one another by axially extending recessed areas 22b. The illustrated splines 22a circumferentially spaced about the interior of the female member 22 and extend radially inwardly toward the male member 21. The splines 21a of the male member 21 extend within the recessed areas 22b of the female member 22, and the splines 22a of the female member 22 extend within the recessed areas 21b of the male member 21. As a result, the male and female splined members 21 and 22 cooperate with one another for concurrent rotational movement, while simultaneously permitting a limited amount of axial movement to occur therebetween.

It will be appreciated that any desired number of such splines 21a and 22a and recessed areas 22a and 22b may be provided on the male and female splined members 21 and 22. Also, the splines 21a and 22a of the male and female members 21 and 22 may have any desired shape, such as straight sided, involute, flat root, fillet root, and the like. Alternatively, this invention contemplates that the male and female members 21 and 22 may have no splines 21a and 22a provided thereon, but rather may be formed having cooperating shapes that allow for both concurrent rotational movement and relative axial movement. For example, the male and female members 21 and 22 may be formed having cross sectional shapes that are square, hexagonal, oval, and the like. The male and female members 21 and 22 may be formed from any desired material or combination of materials. Typically, the male and female members 21 and 22 are formed from a rigid, metallic material such as steel, cast iron, aluminum, titanium, and the like.

The outer surface of the male member 21 has a coating 30 of a material provided thereon. The coating 30 may, as illustrated in FIG. 3, be applied only to that portion of the outer surface of the male member 21 that cooperates with the inner surface of the female member 22 in the manner described above. Thus, in the illustrated embodiment, the coating 30 is applied over the splines 21a and the recessed areas 21b of the male member 21. The coating 30 may be formed from any desired material, but preferably is a polymer material such as, for example, Nylon 6,6. The coating 30 may be applied in any suitable manner, such as by fluidized bath, spray coating, dipping, painting, heat shrink applied tubing, and the like. The coating 30 may have any desired thickness such as, for example, in the range of from about 0.005 inch to about 0.062 inch and more preferably in the range of from about 0.010 inch to about 0.040 inches thick.

The portions of the coating 30 that are provided on the surfaces of the splines 21a of the male member 21 are shaped to provide one or more relatively thick portions, indicated as ribs 31, that are separated from one another by relatively thin portions, indicated as lands 32. In the illustrated embodiment, each of the radially outermost surfaces of the splines 21a of the male member 21 is provided with a plurality of ribs 31 and a plurality of lands 32. However, it will be appreciated that the splines 21a of the male member 21 may be provided with any desired number or numbers of such ribs 31 and lands 32. Also, it will be appreciated that the ribs 31 and lands 32 may be provided at any desired location or locations on the splines 21a of the male member 21, such as on the sides thereof. Furthermore, it will be appreciated that only a single rib 31 may be provided on some or all of the surfaces of the splines 21a of the male member 21. In the illustrated embodiment, the ribs 31 on each of the splines 21a of the male member 21 are axially aligned with one another, although such is not required. Also, in the illustrated embodiment, the ribs 31 on the splines 21a of the male member 21 are circumferentially aligned with one another so as to define annular ribs 31 that are separated by the annular lands 32. However, such an alignment is not necessary, and the ribs 31 on the splines 21a of the male member 21 may be circumferentially offset from one another if desired.

As shown in FIG. 3, the radially outermost surfaces of the ribs 31 engage the radially inwardly facing surfaces of the recessed areas 22b of the female member 22. Such engagement minimizes the amount of undesirable looseness between male and female members 21 and 22. However, if desired, the radially outermost surfaces of the ribs 31 may be spaced apart from the radially inwardly facing surfaces of the recessed areas 22b of the female member 22 by a distance. The amount of this distance would typically be relatively small so as to still maintain a relatively small amount of looseness between male and female members 21 and 22. In either instance, the lands 32 are spaced apart from the radially inwardly facing surfaces of the recessed areas 22b of the female member 22 by a somewhat greater distance. By limiting the amount of the surface area of the coating 30 applied to the splines 21a of the male member 21 that engages (or is closely disposed adjacent to) the female member 22, the magnitude of the force that is required to effect relative axial movement of the male and female members 21 and 22 is desirably minimized.

The ribs 31 and the lands 32 can be provided in the coating 30 in any desired manner. Preferably, the coating 30 is initially applied over the male member 21 in a generally uniform manner. Thereafter, portions of the coating 30 are removed to define the ribs 31 and the lands 32. Such removal of the portions of the coating 30 can be accomplished by pot broaching, milling, hobbing, or any other desired material removal process. Then, ribs 31 (and any other desired portions of the coating 30) can be machined, typically in a lathe, to precisely define the shapes and sizes thereof. Alternatively, the coating 30 can be applied in such a manner that the ribs 31 and the lands 32 are provided during such application, such as by molding.

Although not illustrated, it will be appreciated that the coating 30, including the ribs 31 and the lands 32, could alternatively be provided on the splines 22a or other portions of the female member 22 for cooperation with the splines 21a or other portions of the male member 21 in a similar manner.

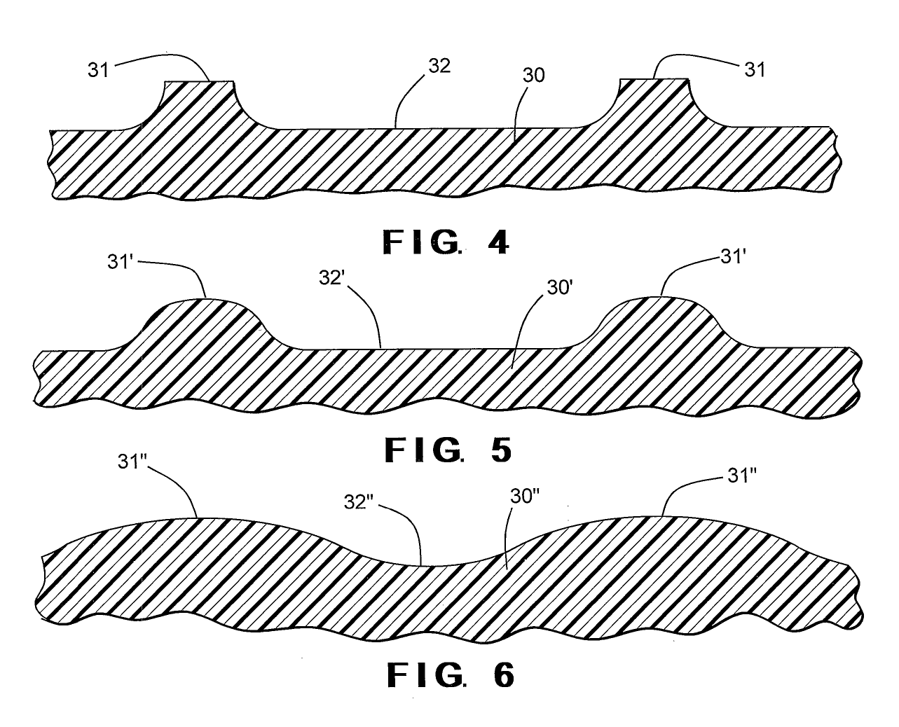

FIG. 4 illustrates in detail the structure of the ribs 31 and the lands 32 of the coating 30 illustrated in FIGS. 1, 2, and 3. As shown therein, both the ribs 31 and the lands 32 of the coating 30 are formed having substantially flat, radially outwardly facing surfaces. In a first alternative embodiment illustrated in FIG. 5, the ribs 31′ of the coating 30′ are formed having substantially curved radially outwardly facing surfaces, while the lands 32′ of the coating 30′ are formed having substantially flat, radially outwardly facing surfaces. In a second alternative embodiment illustrated in FIG. 6, both the ribs 31″ and the lands 32″ of the coating 30″ are formed having substantially curved radially outwardly facing surfaces.

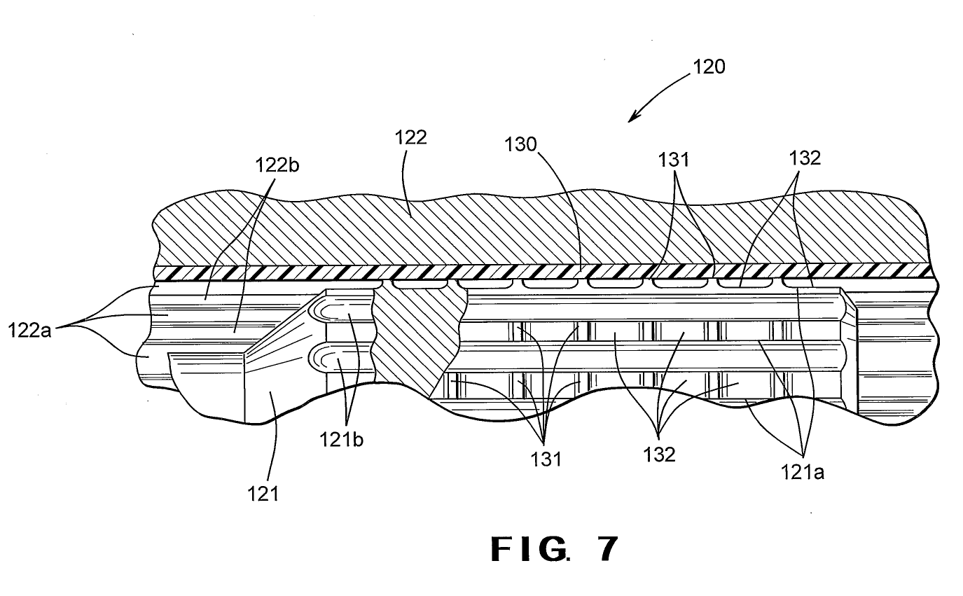

FIG. 7 is a sectional elevational view similar to FIG. 3 of a second embodiment of the slip joint, indicated generally at 120, illustrated in FIGS. 1 and 2. As shown therein, the slip joint 120 includes a male member 121 that can be secured to the first end fitting 15a of the first universal joint 15 and a female member 122 that can be secured to the forward end of the driveshaft tube 14. In the illustrated embodiment, the male member 121 is an externally splined member that includes a plurality of axially extending splines 121a that are separated from one another by axially extending recessed areas 121b. The illustrated splines 121a are circumferentially spaced about the exterior of the male member 121 and extend radially outwardly toward the female member 122. Similarly, the female member 122 is a hollow, internally splined member that includes a plurality of axially extending splines 122a that are separated from one another by axially extending recessed areas 122b. The illustrated splines 122a circumferentially spaced about the interior of the female member 122 and extend radially inwardly toward the male member 21. The splines 121a of the male member 121 extend within the recessed areas 122b of the female member 122, and the splines 122a of the female member 122 extend within the recessed areas 121b of the male member 121. As a result, the male and female splined members 121 and 122 cooperate with one another for concurrent rotational movement, while simultaneously permitting a limited amount of axial movement to occur therebetween.

The inner surface of the female member 122 has a coating 130 of a material provided thereon. The coating 130 may be applied only to that portion of the inner surface of the female member 122 that cooperates with the outer surface of the male member 121 in the manner described above. Thus, in the illustrated embodiment, the coating 130 is applied over the splines 122a and the recessed areas 122b of the female member 122. The coating 130 may be formed from a material having the same characteristics as the coating 30 described above. However, in this embodiment of the invention, the inner surface of the coating 130 has no ribs 31 or lands 32 provided therein as described above.

Rather, the splines 121a of the male member 121 are shaped to provide one or more relatively thick portions, indicated as ribs 131, that are separated from one another by relatively thin portions, indicated as lands 132. In the illustrated embodiment, each of the radially outermost surfaces of the splines 121a of the male member 121 is provided with a plurality of ribs 131 and a plurality of lands 132. However, it will be appreciated that the splines 121a of the male member 121 may be provided with any desired number or numbers of such ribs 131 and lands 132. Also, it will be appreciated that the ribs 131 and lands 132 may be provided at any desired location or locations on the splines 121a of the male member 121, such as on the sides thereof. Furthermore, it will be appreciated that only a single rib 131 may be provided on some or all of the surfaces of the splines 121a of the male member 121. In the illustrated embodiment, the ribs 131 on each of the splines 121a of the male member 121 are axially aligned with one another, although such is not required. Also, in the illustrated embodiment, the ribs 131 on the splines 121a of the male member 121 are circumferentially aligned with one another so as to define annular ribs 131 that are separated by the annular lands 132. However, such an alignment is not necessary, and the ribs 131 on the splines 121a of the male member 121 may be circumferentially offset from one another is desired. The ribs 31 and the lands 32 can be provided in the splines 121a of the male member 121 in any desired manner.

As shown in FIG. 7, the radially outermost surfaces of the ribs 131 engage the radially inwardly facing surface of the coating 130 provided on the recessed areas 122b of the female member 122. Such engagement minimizes the amount of undesirable looseness between male and female members 121 and 122. However, if desired, the radially outermost surfaces of the ribs 131 may be spaced apart from the radially inwardly facing surfaces of the recessed areas 122b of the female member 122 by a distance. The amount of this distance would typically be relatively small so as to still maintain a relatively small amount of looseness between male and female members 121 and 122. In either instance, the lands 132 are spaced apart from the radially inwardly facing surfaces of the recessed areas 122b of the female member 122 by a somewhat greater distance. By limiting the amount of the surface area of the male member 121 that engages (or is closely disposed adjacent to) the coating 130 provided on the female member 122, the magnitude of the force that is required to effect relative axial movement of the male and female members 121 and 122 is desirably minimized.

Although not illustrated, it will be appreciated that the ribs 131 and the lands 132 could alternatively be provided on the splines 122a or other portions of the female member 122 for cooperation with the coating 130 provided on the splines 121a or other portions of the male member 121 in a similar manner.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A slip joint comprising:
male and female members that cooperate for concurrent rotational movement and for relative axial movement;
a coating of a material provided on one of the male and female members and that cooperates with the other of the male and female members; and
a rib provided on one of the male and female members and that cooperates with the other of the male and female members.

2. The slip joint defined in claim 1 wherein the coating of the material is provided on the male member.

3. The slip joint defined in claim 1 wherein the rib is provided on the male member.

4. The slip joint defined in claim 1 wherein the coating of the material is provided on the male member and wherein the rib is provided on the male member.

5. The slip joint defined in claim 1 wherein the coating of the material is provided on the male member and wherein the rib is provided in the coating of the material on the male member.

6. The slip joint defined in claim 1 wherein the coating of the material is provided on the female member.

7. The slip joint defined in claim 1 wherein the rib is provided on the female member.

8. The slip joint defined in claim 1 wherein the coating of the material is provided on the female member and wherein the rib is provided on the female member.

9. The slip joint defined in claim 1 wherein the coating of the material is provided on the female member and wherein the rib is provided in the coating of the material on the female member.

10. The slip joint defined in claim 1 wherein the coating of the material is provided on the male member and wherein the rib is provided on the female member.

11. The slip joint defined in claim 1 wherein the coating of the material is provided on the female member and wherein the rib is provided on the male member.

12. The slip joint defined in claim 1 wherein a plurality of ribs is provided on one of the male and female members, wherein the ribs are separated by lands.

13. The slip joint defined in claim 12 wherein the plurality of ribs are circumferentially aligned with one another.

14. The slip joint defined in claim 12 wherein both the ribs and the lands are formed having substantially flat, radially outwardly facing surfaces.

15. The slip joint defined in claim 12 wherein the ribs are formed having substantially curved radially outwardly facing surfaces, while the lands are formed having substantially flat, radially outwardly facing surfaces.

16. The slip joint defined in claim 12 wherein both the ribs and the lands are formed having substantially curved radially outwardly facing surfaces.

17. The slip joint defined in claim 1 wherein each of the male and female members is provided with splines that cooperate for concurrent rotational movement and for relative axial movement, the coating of the material is provided on the splines of one of the male and female members, and the rib is provided on the splines of one of the male and female members.

18. A sliding spline type of slip joint comprising:
male and female splined members having portions that cooperate for concurrent rotational movement and for relative axial movement;
a coating of a material provided on the portion of the male splined member; and
a rib provided on the coating of the material that cooperates with the portion of the female member.

19. The slip joint defined in claim 18 wherein a plurality of ribs is provided on one of the male and female members, wherein the ribs are separated by lands.

20. The slip joint defined in claim 19 wherein the plurality of ribs are circumferentially aligned with one another.
